(19) United States
(12) Patent Application Publication
(10) Pub. No.: US 2006/0123675 A1
(43) Pub. Date: Jun. 15, 2006

(54) Sticker calendar

(76) Inventor: Tuula Borecky, Oakville (CA)

Correspondence Address: Kimberly A. McManus;Sim & McBurney, 6th Floor, 330 University Avenue, Tornoto, ON, M5G 1R7, CA

(21) Appl. No.: 11/008,239

(22) Filed: Dec. 10, 2004

(51) Int. Cl. G09D 3/04

(52) U.S. Cl. 40/119

(57) ABSTRACT

The invention relates to a sticker calendar that has one or more pages. In one embodiment, each page has a base sheet that has a time period portion. One or more image stickers are removably coupled to the base sheet, outside the time period portion. The stickers are re-useable for various applications, such as for playing and/or decorating with them at the end of the month. In another embodiment, each page has a base sheet and one or more stickers that are removably coupled to the base sheet. The stickers identify a time period and have an entry area. The entry area permits a user to enter information associated with that particular time period. The stickers having that information may then be removed and taken by the user such that the user will be able to determine the time period the information is associated with.

### FIELD OF THE INVENTION

The present invention relates, in general, to calendars. More particularly, the present invention relates to sticker calendars.

### BACKGROUND OF THE INVENTION

Traditional types of calendars include wall calendars and desk calendars. Some wall calendars are configured to be hung on a wall opened to show a top page with a design, photograph or other decoration and a bottom page showing the month and days of the month divided into weeks. Others are configured to be hung on a wall with only one page showing a design, photograph or other decoration at the top half of the page and the month and the days of the month divided into weeks at the bottom half of the page. Wall calendars usually serve both a calendar function and a decorative function. Traditional desk calendars typically show the month and the days of the month divided into weeks, which are mounted in or on a holder for display.

Various types of calendars have evolved over the years. In particular, U.S. Pat. No. 3,919,796 is directed to a calendar with the day numerals of the month imprinted on a base sheet and having a number of individual removable seals covering a different day on the base sheet. The seals can be peeled off of the base sheet to uncover the day numeral imprinted on the base sheet. Each seal has the same day numeral as the day numeral imprinted on the base sheet underneath the seal. The purpose of such a calendar is to permit a user to determine, at a glance, what date and what day of the week any given day is.

In most instances, once a calendar has expired, it is typically discarded. However, in certain instances, calendars have been known to be re-used for their artwork. For example, U.S. Pat. No. 4,757,624 to Holec is directed to the detachment of artwork from calendars and to re-using it as postcards. In another instance, U.S. Pat. No. 5,292,154 to Williams is directed to a combination of a pictorial calendar having artwork, expired calendar information and a calendar sticker covering the expired calendar information. The calendar sticker has unexpired calendar information printed thereupon.

There is still a need, however, for a calendar, wherein one or more portions of the calendar are removable and re-useable.

### SUMMARY OF THE INVENTION

In one aspect of the present invention, there is provided a calendar comprising:
at least one page comprising:
   a base sheet having a time period portion; and
   at least one image sticker being removably coupled to the base sheet, outside the time period portion.

In another aspect of the present invention, the calendar further comprises at least one sticker identifying a time period and being removably coupled to the time period portion of the base sheet.

In a further aspect of the present invention, there is provided a calendar comprising:
at least one page comprising:
   a base sheet; and
   at least one sticker identifying a time period and being removably coupled to the base sheet, the at least one sticker identifying the time period having an entry area permitting entry of information associated with the time period.

In yet another aspect of the present invention, there is provided a calendar comprising:
at least one page comprising:
   a base sheet having a first surface and a second surface; and
   a plurality of stickers removably coupled to the base sheet and re-useable as a sticker for a further application, the stickers covering a majority of at least one surface of the base sheet and comprising at least one image sticker and at least one sticker identifying a time period.

In another aspect of the present invention, there is provided a sticker calendar comprising:
at least two pages comprising:
   a first page comprising:
      a base sheet; and
      at least one image sticker removably coupled to the base sheet; and
   a second page comprising:
      a base sheet; and
      at least one sticker identifying a time period and being removably coupled to the base sheet.

The novel features of the present invention will become apparent to those of skill in the art upon examination of the following detailed description of the invention. It should be understood, however, that the detailed description of the invention and the specific examples presented, while indicating certain embodiments of the present invention, are provided for illustration purposes only because various changes and modifications within the spirit and scope of the invention will become apparent to those of skill in the art from the detailed description of the invention and claims that follow.

### BRIEF DESCRIPTION OF THE DRAWINGS

Certain embodiments of the present invention will now be described more fully with reference to the accompanying drawings, wherein like numerals denote like parts:

FIG. 1 shows a front view of a first page of a sticker calendar of in accordance with an embodiment of the present invention;

FIG. 2 shows a perspective view of several pages of the sticker calendar of FIG. 1;

FIG. 3 shows a cross-sectional view of the first page of the sticker calendar taken along line 3-3 in FIG. 1;

FIG. 4 shows a perspective view of a sticker calendar similar to the sticker calendar of FIGS. 1 and 2, except that the sticker calendar of this particular embodiment is bound at the mid-section of the calendar;

FIG. 5 shows a front view of a first page of a sticker calendar of a further embodiment of the present invention;

FIG. 6 shows a cross-sectional view of the first page of the sticker calendar taken along line 6-6 in FIG. 5;

FIG. 7 shows a front view of a first page of a sticker calendar of another embodiment of the present invention; and

FIG. 8 shows a cross-sectional view of the first page of the sticker calendar taken along line 8-8 in FIG. 7.

### DETAILED DESCRIPTION

The present invention relates to a sticker calendar. The sticker calendar has one or more stickers identifying, for example, images and/or time periods. For instance, the stickers may represent images, months, days of the week, and/or days of the month. Each sticker may be removable and re-useable as a sticker for a further application such as, and not to be limited to, crafts, scrapbooks, etc. For example, the stickers may be used by children for creative crafts and playing such as making birthday cards and games, to name a few. Scrapbookers may use the stickers to adorn scrapbook pages. In other examples, image stickers of the calendar may be applied to the days of the month of the calendar to indicate special days, such as birthdays. In addition, stickers identifying a particular time period, such as a day of the month, may be used to write notes or other information thereon (e.g. dentist appointment) and subsequently, peeled therefrom and applied to a daytimer or school notebook as a reminder. The stickers of the days of the month may also be used to keep a daily journal, e.g. baby's first year. For instance, the highlights of what a baby does each day, e.g. first smile, first word, begins to crawl etc., may be recorded on a sticker representing each day of the month and these daily stickers can then be removed and applied into a scrapbook.

In a first embodiment, the calendar of the present invention has one or more pages. Each page has a base sheet that has a time period portion. One or more image stickers are removably coupled to the base sheet, outside the time period portion. The one or more image stickers are not associated with a particular time period. The calendar may also have one or more stickers identifying a time period. Each of these stickers identifying a time period is removably coupled to the time period portion of the base sheet.

In a second embodiment, the calendar of the present invention has one or more pages. Each page has a base sheet and one or more stickers that are coupled to the base sheet. The stickers identify a time period and have an entry area. The entry area permits a user to enter information associated with that particular time period, such as, for example, information noted above. The stickers having the additional information added thereon can then be removed and taken by the user such that the user will be able to determine the time period the information is associated with. The calendar may also have one or more image stickers removably coupled to the base sheet.

In a third embodiment, the calendar of the present invention has one or more pages. Each page has a base sheet having a first surface and a second surface and stickers removably coupled to the base sheet. The stickers cover a majority of one surface of the base sheet. The stickers comprise one or more image stickers and one or more stickers identifying a time period. Each sticker is re-useable for a further application, such as noted above, and therefore, a substantial amount of this particular calendar is re-useable. With respect to the coverage of the base sheet, typically, greater than about 50% of one surface of the base sheet is covered with stickers. In some examples, at least about 60% of one surface of the base sheet is covered with stickers or at least about 70% of one surface of the base sheet is covered with stickers.

In a fourth embodiment, the calendar of the present invention has two or more pages. A first page has a base sheet. One or more image stickers are removably coupled to the base sheet. A second page has a base sheet identifying a time period. The base sheet has one or more stickers identifying a time period that are removably coupled to the base sheet.

The sticker calendar of the present invention may be a monthly or yearly renewed calendar (e.g. it may display the dates of a single month or of a whole year on one sheet). In particular, the sticker calendar may be-any type of calendar, for example, a wall or desk calendar. With respect to a sticker wall calendar, a variety of embodiments are possible. The sticker calendar may be configured to be hung on a wall opened to show a top page having one or more image stickers and a bottom page having one or more stickers identifying a month and either a day or days of the month. In another embodiment, the sticker calendar is configured to be hung on a wall, showing only one page having one or more image stickers at the top half of the page and one or more stickers identifying a month and either a day or days of the month at the bottom half of the page. In other embodiments, the sticker(s) representing the image that are on the top page or top half of the calendar in the previous embodiments are, instead, on the bottom page or bottom half of the page and the stickers identifying one or more days and month are on the top page or top half of the calendar. Several other alternatives are possible. In further embodiments, the image stickers are on the top page or top half of the calendar and one or more days of the month are imprinted on the bottom page or bottom half of the page. Several other alternatives are possible. The stickers representing the images, months and/or days may appear anywhere suitable in the calendar.

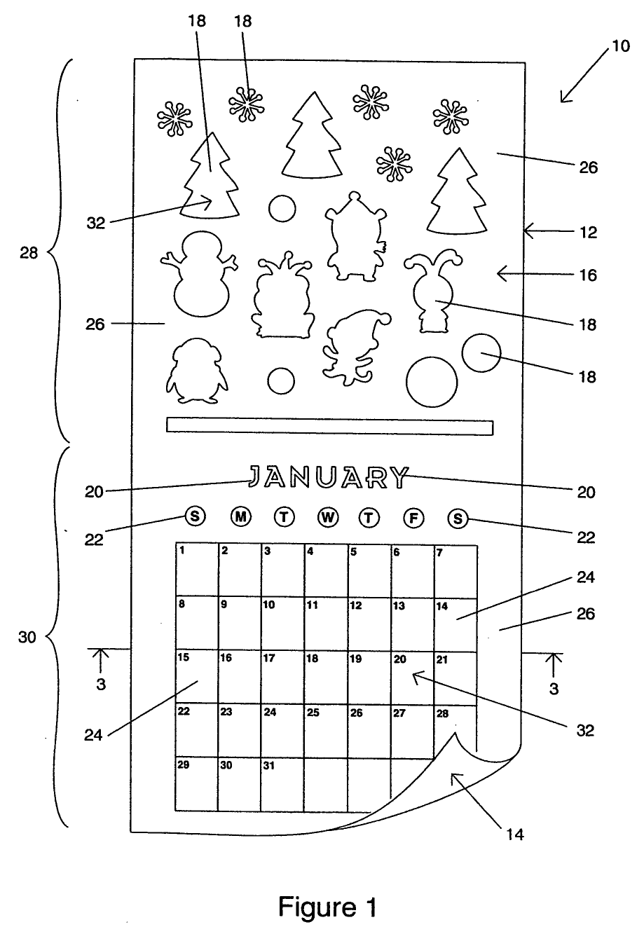

A specific embodiment of the sticker calendar of the present invention is shown in FIGS. 1 to 3 and indicated generally by the numeral 10. The sticker calendar 10 is a wall calendar. FIG. 1 shows a first page 12 of the sticker calendar 10. The first page 12 has a base sheet 14 and a sticker sheet 16 coupled to the base sheet 14. The sticker sheet 16 is a generally flexible sticker paper. The sticker sheet 16 has several die-cut stickers 18, 20, 22 and 24 and a remaining region 26. The sticker sheet 16 and base sheet 14 have a top half 28 and a bottom half 30 (or time period portion). The top half 28 of the sticker sheet 16 has a number of image stickers identifying a variety of images 18. The bottom half 30 of the sticker sheet comprising the stickers 16 has several stickers identifying each letter of the month 20 of January, seven stickers identifying each day of a week 22 (e.g. Sunday, Monday etc.), and several stickers identifying each day of the month 24 (e.g. numeral).

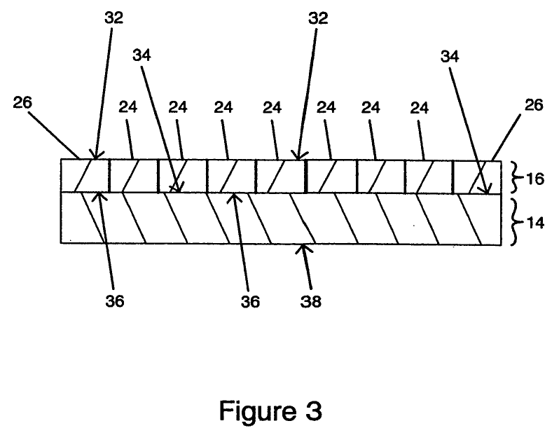

Each of the stickers 18, 20, 22 and 24 has a first surface 32 and a second surface 34 (shown in FIG. 3, which shows a sectional view of the sticker calendar 10 taken along line 3-3 in FIG. 1). As shown in FIG. 3, the second surface 34 is coupled to a first surface 36 of the base sheet 14. The base sheet 14 has a second surface 38.

The second surface 34 of the stickers 18, 20, 22 and 24 has an adhesive substance and the first surface 36 of the base sheet 14 has a release substance that permits the stickers 18, 20, 22 and 24 to be removed from the base sheet 14 and reused on another surface. The first surface 32 of the image stickers 18 do not have an image shown thereon, however, the stickers 18 themselves are shaped in an image of characters and other shapes. The first surface 32 of the stickers 20 do not have the month thereon, however, the stickers 20 themselves are shaped into each letter of the month. With respect to the first surface 32 of the stickers 22, each sticker 22 has a letter for each day of the week thereon. Each sticker 22 is shaped as a circle. With respect to the first surface 32 of the stickers 24, each sticker 24 has the day (e.g. the numeral) of the month thereon. Each sticker 24 is shaped as a square.

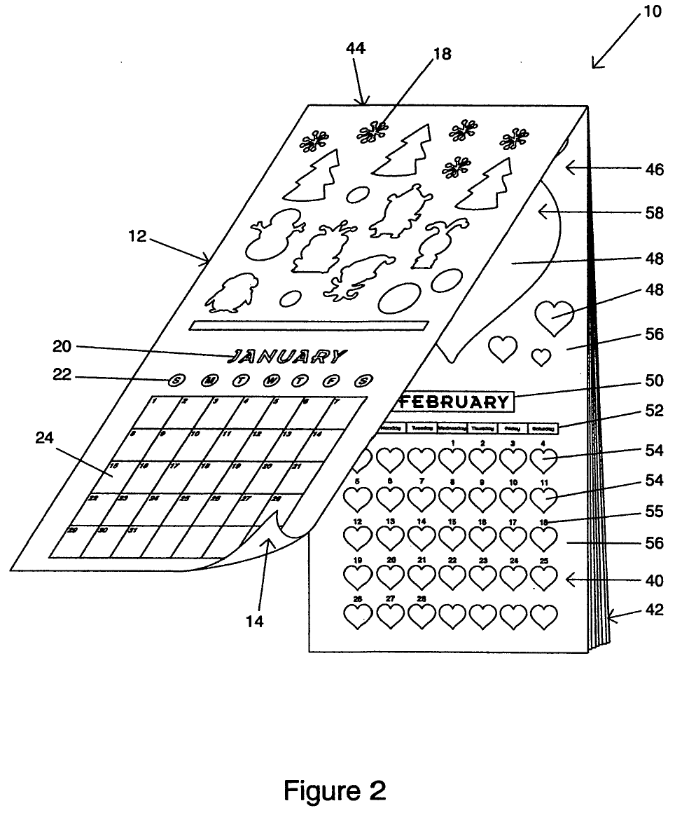

FIG. 2 shows the first page 12, a second page 40, and other pages 42 of the sticker calendar 10. The pages 12, 40 and 42 of the sticker calendar 10 are bound together at the top 44 of the calendar 10. The second page 40, like the first page 12, has a base sheet 14 (not shown) and a sticker sheet 46 coupled to the base sheet 14. The sticker sheet 46 has several die-cut stickers 48, 50, 52 and 54 and a remaining region 56. A top half of the sticker sheet 46 has a number of stickers representing a variety of images 48. A bottom half (or time period portion) of the sticker sheet 46 has one sticker identifying the month 50 of February, seven stickers identifying each day of a week 52 (e.g. Sunday, Monday etc.), and several stickers identifying each day of the month 54 (e.g. numeral).

Each of the stickers 48, 50, 52 and 54 is coupled to the base sheet 14, as described above with respect to the first page 12. The first surface 58 of stickers 48 do not have an image shown thereon, however, the stickers 48 themselves are shaped in an image of a heart. The first surface 58 of the sticker 50 has the month, February, imprinted thereon. With respect to the first surface 58 of the stickers 52, each sticker 52 has a day of the week imprinted thereon. Each sticker 52 is shaped as a rectangle. With respect to the stickers 54, each sticker 54 represents a day of the month and is shaped in an image of a heart. The actual numeral 55 for the date is imprinted on the remaining region 56 of the sticker sheet 46 above each sticker 54.

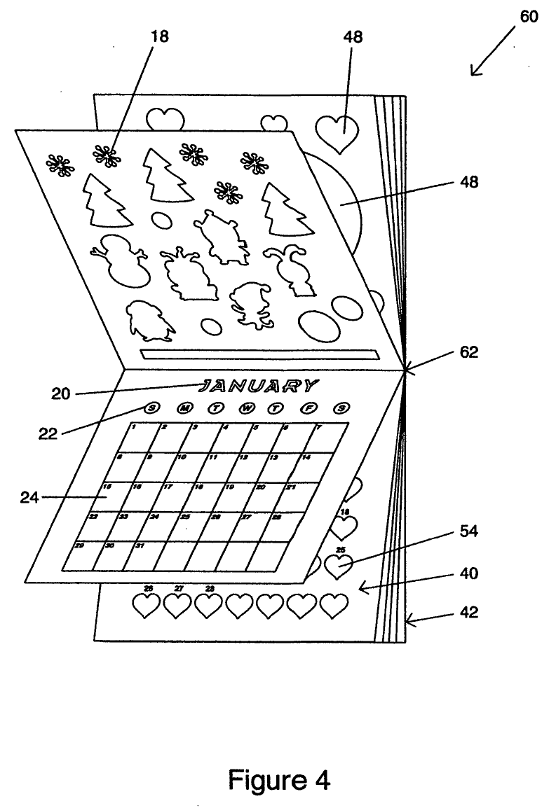

FIG. 4 shows another embodiment of the sticker calendar 60. The calendar is bound near about a mid-section 62 of the calendar 60.

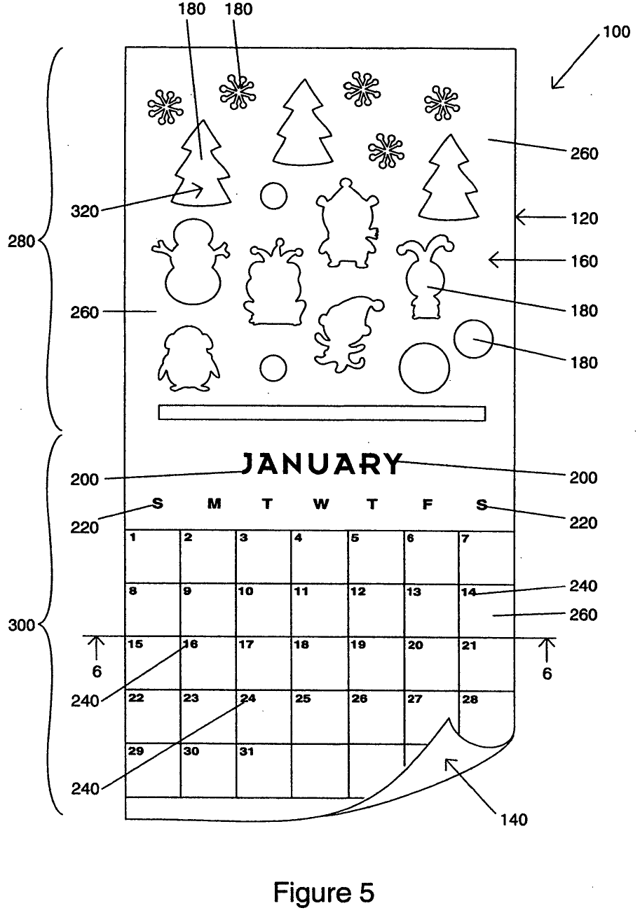

FIG. 5 shows a further embodiment of the sticker calendar of the present invention. The sticker calendar is indicated generally by the numeral 100. The sticker calendar 100 is a wall calendar. FIG. 5 shows a first page 120 of the sticker calendar 100. The first page 120 has a base sheet 140 and a sticker sheet 160 coupled to the base sheet 140. The sticker sheet 160 is a generally flexible sticker paper. The sticker sheet 160 has several die-cut stickers 180 and a remaining region 260. The sticker sheet 160 and base sheet 140 have a top half 280 and a bottom half 300 (or time period portion). The top half 280 of the sticker sheet 160 has a number of image stickers representing a variety of images 180 and a remaining region 260. A bottom half 300 of the sticker sheet 160 has the remaining region 260, which is imprinted with the month 200 of January, imprinted with letters identifying the days of the week 220 (e.g. Sunday, Monday etc.), and imprinted with days of the month 240 (e.g. numeral).

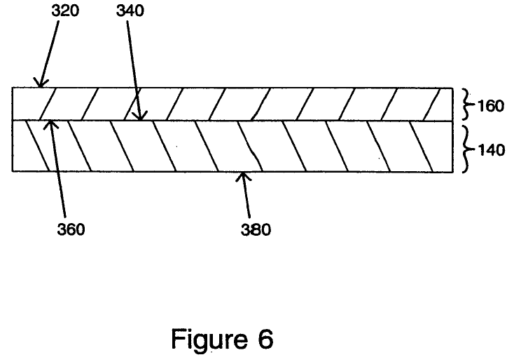

Each of the stickers 180 has a first surface 320 and a second surface 340 (shown in FIG. 6, which shows a sectional view of the sticker calendar 100 taken along line 6-6 in FIG. 5). As shown in FIG. 5, the second surface 340 is coupled to a first surface 360 of the base sheet 140. The base sheet 140 has a second surface 380.

The second surface 340 of the stickers 180 has an adhesive substance and the first surface 360 of the base sheet 140 has a release substance that permits the stickers 180 to be removed from the base sheet 140 and reused on another surface. The first surface 320 of the stickers 180 do not have an image shown thereon, however, the stickers 180 themselves are shaped in an image of characters and other shapes.

Alternative embodiments of the above-mentioned embodiments, variations, and combinations of the sticker calendar are also possible.

With respect to the time period portion of the calendar, this portion may be designated as any one of a variety of areas of the page. For example, and without being limited thereto, the time period portion may be the top half of the page and the portion of the base sheet having the image sticker(s) may be the bottom half of the page. In addition, the percentage of area covered by the time period portion may vary. For instance, the time portion may cover about 10% to about 90% of the page; typically, about 30% to about 60%.

With respect to the portion of the base sheet outside the time period portion, this portion may have one or more image stickers. With respect to the time period portion, the time period portion comprises, for example, imprinted matter identifying time period(s) and/or one or more stickers identifying time period(s), which may include, for example and without being limited thereto, sticker(s) with a time period imprinted thereon or a time period imprinted on the base sheet and associated with a sticker. The term time period used herein may be any suitable time period, for example, at least a year, a month, at least one day of the month, at least one day of a week, and combinations thereof.

The stickers used in the calendar of the present invention may comprise individual sticker(s) coupled to the base sheet and/or may comprise sticker sheet(s) having the stickers. With respect to the term individual sticker(s), such sticker(s) are not included in a sticker sheet but, instead, are separate individual sticker(s) comprising, for example, image sticker(s) and/or sticker(s) identifying a time period. With respect to the sticker sheet, the sticker sheet comprises a sheet having, for example, image stickers and/or stickers identifying a time period die-cut in the sheet. The remaining region of the sticker sheet may contain imprinted matter. For example, the time period, such as the month, the days of the week, and/or the days of the month, may be imprinted on the sticker sheet in these regions and the die cut stickers of the sheet may contain the images.

The stickers may be made of any suitable material. For example, the sticker sheet may be made from a generally flexible sticker paper. The sticker(s) may have an adhesive substance, for example, a pressure-sensitive adhesive, which allows the sticker(s) to be removed easily from the base sheet and re-used in other application(s). The stickers may be made of materials other than paper, such as epoxies (e.g. jewellery-like material), fabrics, magnets etc. and combinations thereof. Paper may also be included in combination with these other materials as well. Typically, the magnets, for instance, include a paper material having an image and/or time period. There may also be an entry area for writing information thereon. The paper material may be made of a material such that the information included thereon may be wipeable and re-useable. The sticker(s) may be made of a plastic material that allows the sticker to cling to the base sheet without having to use an adhesive substance. For example, the sticker may be made of a cling vinyl.

For both the sticker sheet and the base sheet, a suitable paper, for example, is that supplied by Fasson™ and known as 60 lb Archival Semi-gloss™ with 40 lb liner. Another suitable paper is that supplied by MACtac™ known as Starliner® 60 lb lyric white, matte coated litho with 80 lb liner.

The first surface of the sticker(s) may have an image, a day of the week, a day of the month, a month, and/or etc. imprinted thereon. The sticker(s) may be a variety of shapes, sizes and colours to provide an appropriate calendar. The image stickers may have a particular shape and/or an image imprinted thereon. The sticker(s) identifying a time period may be a variety of shapes associated with the time period (e.g. birthday cakes, flowers (spring), leaves (autumn), hearts, squares, round, etc.). The sticker(s) may have the time period imprinted thereon or associated therewith. For example, in FIG. 2, sticker 54 and numeral 55 is associated therewith. In addition, another sticker may be coupled to, for example, sticker 55, identifying the time period. An image may also be imprinted on the sticker or an image sticker may be coupled to the sticker. Examples of sticker(s) identifying a time period comprise a month wherein the stickers are shaped in letters (as shown in FIG. 1) or a sticker with the month imprinted thereon. With respect to the days of the week, each sticker may have the day imprinted thereon, for example. There may also be one sticker representing all seven days of the week. The stickers for each day of the month may have the day (e.g. numeral) imprinted thereon, may have a particular shape and/or an image imprinted thereon, or the day may be represented by stickers in the shape of numbers, to name a few examples.

The first and/or second surface of the base sheet may have certain information imprinted thereon. For instance, once the sticker, coupled to a particular portion of the surface of the base sheet, is removed, the imprinted information on the base sheet is revealed. This information may be, but not limited to, an image, the month, the day of the week, etc. depending on the portion of the calendar. In other embodiments, the first surface of the base sheet may be covered with stickers and the second surface of the base sheet may have information imprinted thereon, which may include, for example, printed games, images for placing the stickers thereon, activities or other ideas for re-using the stickers.

The base sheet may also have stickers on both its' surfaces. For example, a calendar may have 6 pages, each page representing two months. One page, for instance, having a base sheet, wherein on the first surface of the base sheet is a sticker sheet representing the month of January and on the second surface of the base sheet is a sticker sheet representing the month of February. In addition, one page may have two base sheets. One base sheet has a sticker sheet on the first surface of the base sheet representing the month of January and the other base sheet has a sticker sheet on the first surface of the base sheet representing the month of February. The second surface of one base sheet is coupled to the second surface of the other base sheet to form the page.

The surface of the base sheet that is coupled to the sticker(s) or sticker sheet may have a smooth surface to facilitate removal of the stickers. The surface(s) of the base sheet may be glossy. The surface(s) of the base sheet may have a release substance, such as a suitable wax coating. The base sheet may be, for example, a paper sheet used for typical calendars. The base sheet may also be provided with a backing sheet or other rigid board element. The backing sheet may be, for example, cardboard, plastics, a wooden board or the like. The back of the backing sheet may also include information imprinted thereon. Alternatively, the base sheet itself may be a rigid board element.

In use, the stickers of the sticker calendar of the present invention may be removed at any time during or at the end of each month and re-used.

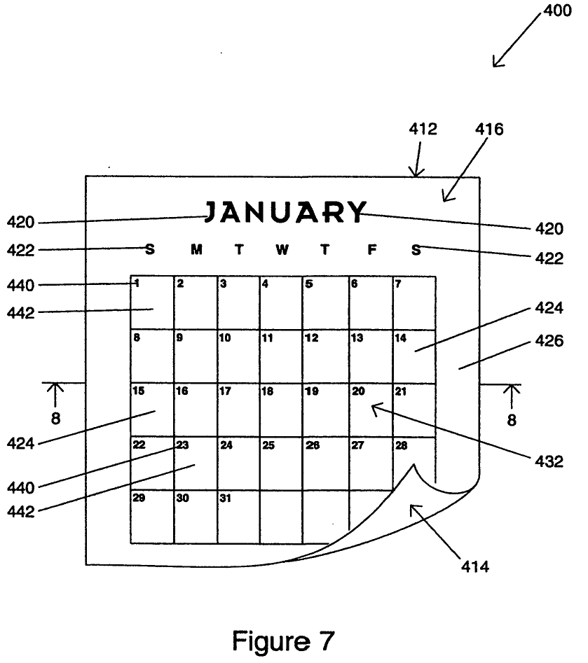

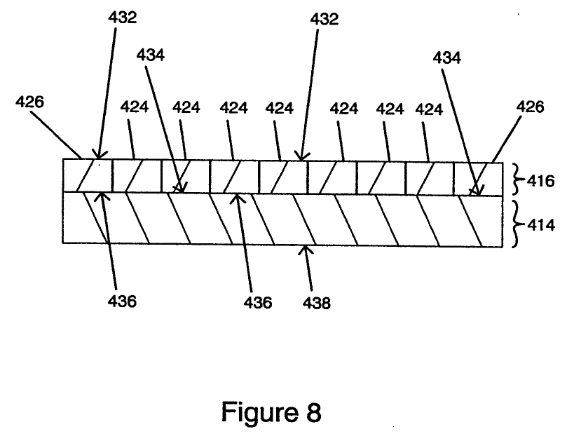

A further embodiment of the sticker calendar of the present invention is shown in FIGS. 7 and 8 and indicated generally by the numeral 400. The sticker calendar 400 is a desk calendar. FIG. 7 shows a first page 412 of the sticker calendar 400. The first page 412 has a base sheet 414 and a sticker sheet 416 coupled to the base sheet 414. The sticker sheet 416 is a generally flexible sticker paper. The sticker sheet 416 has several die-cut stickers 424 and a remaining region 426. The sticker sheet 416 has several stickers identifying each day of the month 424 and has the month of January 420 and each day of the week 422 imprinted on the remaining region 426 of the sticker sheet 416.

Each of the stickers 424 has a first surface 432 and a second surface 434 (shown in FIG. 8, which shows a sectional view of the sticker calendar 400 taken along line 8-8 in FIG. 7). As shown in FIG. 8, the second surface 434 is coupled to a first surface 436 of the base sheet 414. The base sheet 414 has a second surface 438.

The second surface 434 of the stickers 424 has an adhesive substance and the first surface 436 of the base sheet 414 has a release substance that permits the stickers 424 to be removed from the base sheet 414 and taken with the user. Each sticker 424 is shaped as a square and identifies a time period 440, which is a numeral for the day of the month imprinted on the first surface 432 of the sticker 424. The stickers 424 also include an entry area 442. The entry area permits the user to enter information associated with that date. The stickers 424, having the additional information added thereon, can then be removed and taken with the user.

Alternative embodiments, variations and combinations of this embodiment of the sticker calendar are possible.

Similar to the stickers discussed above with respect to the previous embodiments, the stickers may comprise individual sticker(s) coupled to the base sheet and/or may comprise sticker sheet(s) having the stickers. The remaining region of the sticker sheet may contain imprinted matter. For example, the time period, such as the month and/or the days of the week may be imprinted on the sticker sheet in these regions and the die cut stickers of the sheet may contain the day(s) of the month.

With respect to the stickers identifying time period(s) (e.g. sticker(s) with a time period imprinted thereon), one or more stickers may be used. The sticker(s) may have an image, a day of the week, a day of the month, a month, and/or etc. imprinted thereon. The sticker(s) may be a variety of shapes, sizes and colours to provide an appropriate calendar. With respect to this particular embodiment, any sticker described herein is suitable, however, at least one sticker identifying a time period has an entry area to permit the user to enter information associated with that time period. The remainder of the calendar may comprise image(s), image sticker(s), additional sticker(s) identifying a time period, and/or matter (e.g. imprinted) identifying a time period. The image stickers may have a particular shape and/or an image imprinted thereon. The sticker(s) identifying a time period may be a variety of shapes associated with the time period (e.g. birthday cakes, flowers (spring), leaves (autumn), hearts, squares, round, etc.). The sticker(s) may have the time period imprinted thereon, as described in the previous embodiments. An image may also be imprinted on the sticker or an image sticker may be coupled to the sticker. A variety of alternatives are possible.

The embodiments of the base sheet described herein are also applicable to this particular embodiment.

In use, information may be written on the stickers, for example, and removed at any time to be taken with the user such that the user will be able to determine the time period the information is associated with.

In general, lithography printing may be used for accurate registration of colors and die-cutting of the sticker sheet(s)/base sheet(s) of the calendar of the present invention. Other suitable printing processes may also be used. For example, less expensive flexographic printing may be used when accuracy is not so critical.

If the binding of the calendar is necessary, the binding may be done on any suitable location on the calendar. Typically, the top or middle of the calendar is bound and may be done using any suitable means. For example, the calendar may be bound using a wire-coil, glue and/or staples.

The sticker calendars of the invention may also be included in a kit with, for example, blank cards, patterned paper, artwork that depicts a scene, and the like, to provide the user with additional items to apply stickers thereto. The kit may also include additional stickers. In addition, the user may be able to create their own calendar from the stickers of the calendar of the present invention. In one embodiment, the user may be able to take stickers identifying suitable time period(s) and image(s) from the calendar to create a new calendar. For example, with respect to a magnetic sticker calendar, the magnetic stickers may be removed and applied to another base sheet (or metal surface such as a refrigerator) to create a new calendar.

The sticker calendars of the invention may also include front and back covers made of any suitable material. These covers may also include stickers.

In one embodiment of the method for making the invention, the calendar has a front cover, a back cover, and twelve pages therebetween. The front and back covers are printed on a 10 point coated card paper. Each page has a semi-gloss sticker sheet on the top and a forty pound base sheet underneath. The sticker sheet is printed using a four color process (CYMK) on the first surface of the sticker sheet and one color, black, on the second surface of the base sheet. Lithography printing is used for accurate registration of colors and die-cutting. A metal die cuts through the sticker sheet to create a series of die-cut stickers. The base sheet remains intact before and after the die-cutting process. The calendar is then bound near the top with glue or wire-coil.

The use of the terms “a”, “an”, and “one” include one or more. The coverage percentages include any ranges therein. For example, greater than about 50% includes any ranges therein (e.g. about 60% to about 100%, about 55% to about 70% etc.).

The embodiments and examples set forth herein are presented to best explain the present invention and its practical application and to thereby enable those skilled in the art to make and utilize the invention. Those skilled in the art, however, will recognize that the description and examples are presented for the purpose of illustration and example only. Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the spirit and scope of the following claims. It is contemplated that the use of the present invention can involve components having different characteristics. It is intended that the scope of the present invention be defined by the claims appended hereto, giving full cognizance to equivalents in all respects.

1. A sticker calendar comprising:
at least one page comprising:
a base sheet having a time period portion; and
at least one image sticker being removably coupled to the base sheet, outside the time period portion.

2. The sticker calendar according to claim 1 further comprises at least one sticker identifying a time period and being removably coupled to the time period portion of the base sheet.

3. The sticker calendar according to claim 1, wherein the time period portion has a time period imprinted thereon.

4. The sticker calendar according to claim 1, wherein the time period is selected from the group comprising at least one year, at least one month, at least one day of the month, at least one day of a week, and combinations thereof.

5. The sticker calendar according to claim 2, wherein the time period is selected from the group comprising at least one year, at least one month, at least one day of the month, at least one day of a week, and combinations thereof.

6. The sticker calendar according to claim 1, wherein said at least one image sticker is a sticker sheet comprising said at least one image sticker.

7. The sticker calendar according to claim 2, wherein said at least one image sticker and said at least one sticker identifying the time period is a sticker sheet comprising said at least one image sticker and said at least one sticker identifying the time period.

8. The sticker calendar according to claim 6, wherein the sticker sheet has at least one die-cut image sticker.

9. The sticker calendar according to claim 8, wherein the sticker sheet further comprises matter imprinted on a remaining region of the sticker sheet that does not contain said at least one die-cut sticker.

10. The sticker calendar according to claim 9, wherein the matter imprinted on the remaining region is a time period.

11. The sticker calendar according to claim 10, wherein the time period is selected from the group comprising at least a year, a month, at least one day of the month, at least one day of a week, and combinations thereof.

12. The sticker calendar according to claim 1, wherein the calendar comprises a plurality of pages, each page comprising one base sheet.

13. The sticker calendar according to claim 2, wherein said at least one sticker identifying the time period comprises a sticker for each day of the month.

14. The sticker calendar according to claim 13, wherein said at least one sticker identifying the time period further comprises at least one sticker identifying a month and/or at least one sticker identifying a day or days of a week.

15. The sticker calendar according to claim 7, wherein said at least one sticker identifying the time period comprises a sticker for each day of the month.

16. The sticker calendar according to claim 15, wherein said at least one sticker identifying the time period further comprises at least one sticker identifying a month and/or at least one sticker identifying a day or days of a week.

17. The sticker calendar according to claim 1, wherein said at least one image sticker comprises a plurality of image stickers.

18. The sticker calendar according to claim 2, wherein said at least one sticker identifying the time period further comprises an image.

19. The sticker calendar according to claim 1, wherein said at least one image sticker comprises at least one of an imprinted image and a shape of an image.

20. The sticker calendar according to claim 18, wherein the image comprises at least one of an imprinted image and a shape of an image.

21. The sticker calendar according to claim 1, wherein the base sheet further comprises matter imprinted thereon.

22. A sticker calendar comprising:
at least one page comprising:
a base sheet; and
at least one sticker identifying a time period and being removably coupled to the base sheet, said at least one sticker identifying the time period having an entry area permitting entry of information associated with the time period.

23. The sticker calendar according to claim 22, wherein the time period is selected from the group comprising at least one year, at least one month, at least one day of the month, at least one day of a week, and combinations thereof.

24. The sticker calendar according to claim 22, wherein said at least one sticker identifying the time period is a sticker sheet comprising said at least one sticker identifying the time period.

25. The sticker calendar according to claim 24, wherein the sticker sheet has at least one die-cut sticker identifying the time period.

26. The sticker calendar according to claim 25, wherein the sticker sheet further comprises matter imprinted on a remaining region of the sticker sheet that does not contain said at least one die-cut sticker identifying the time period.

27. The sticker calendar according to claim 26, wherein the matter imprinted on the remaining region is at least one time period and/or at least one image.

28. The sticker calendar according to claim 27, wherein the time period is selected from the group comprising at least a year, a month, at least one day of the month, at least one day of a week, and combinations thereof.

29. The sticker calendar according to claim 22, wherein the calendar comprises a plurality of pages, each page comprising one base sheet.

30. The sticker calendar according to claim 22, wherein said at least one sticker identifying the time period comprises a sticker for each day of the month.

31. The sticker calendar according to claim 30, wherein said at least one sticker identifying the time period further comprises at least one sticker identifying a month and/or at least one sticker identifying a day or days of a week.

32. The sticker calendar according to claim 24, wherein said at least one sticker identifying the time period comprises a sticker for each day of the month.

33. The sticker calendar according to claim 32, wherein said at least one sticker identifying a time period further comprises at least one sticker identifying a month and/or at least one sticker identifying a day or days of a week.

34. The sticker calendar according to claim 22 further comprises at least one image sticker removably coupled to the base sheet.

35. The sticker calendar according to claim 22, wherein said at least one sticker identifying the time period further comprises an image.

36. The sticker calendar according to claim 34, wherein said at least one image sticker comprises at least one of an imprinted image and a shape of an image.

37. The sticker calendar according to claim 35, wherein the image comprises at least one of an imprinted image and a shape of an image.

38. The sticker calendar according to claim 22, wherein the base sheet further comprises matter imprinted thereon.

39. A sticker calendar comprising:
at least two pages comprising:
a first page comprising:
a base sheet; and
at least one image sticker removably coupled to the base sheet; and
a second page comprising:
a base sheet; and
at least one sticker identifying a time period and being removably coupled to the base sheet.
